(19) United States
(12) Patent Application Publication
(10) Pub. No.: US 2007/0175011 A1
(43) Pub. Date: Aug. 2, 2007

(54) Spindle extension for securing automotive chassis components to automotive body

(76) Inventor: Detlev Ziesel, Lake Orion, MI (US)

Correspondence Address: WOOD, HERRON & EVANS, LLP, 2700 CAREW TOWER, 441 VINE STREET, CINCINNATI, OH, 45202, US

(21) Appl. No.: 11/345,448

(22) Filed: Feb. 1, 2006

(51) Int. Cl. B23P 19/04

(52) U.S. Cl. 29/244

(57) ABSTRACT

Apparatus for securing an automotive chassis component to an automotive body. The apparatus comprises a vertically movable pallet, and a spindle extension mounted on the pallet generally perpendicularly thereto. The spindle extension includes a shaft, a bolt socket on an upper end of the shaft, and a driver socket on a lower end of the shaft. The spindle extension includes a spring operable between the shaft and the pallet which functions to normally bias the spindle extension to the generally perpendicular orientation relative to the pallet.

### FIELD OF THE INVENTION

This invention relates generally to the automotive vehicle manufacturing industry, and more particularly to assembly of automotive chassis components to automotive bodies.

### BACKGROUND OF THE INVENTION

In the automotive vehicle manufacturing industry, it is customary to install various parts onto a vehicle frame to produce a vehicle chassis, and then “marry” the vehicle chassis to a vehicle body. The vehicle frame is first inverted or turned “upside down” so that certain suspension components such as front and rear upper and lower control arms, and knuckles with hubs, can be installed on the frame. Next the frame is turned “right side up” so that further parts such as the power train, brake lines, wiring harnesses, and wheels can be installed on the frame, thereby forming the chassis (sometimes also referred to as “chassis frame”). For techniques of marrying an automotive chassis to an automotive body, see U.S. patent application Ser. Nos. 11/112,599 and 60/632,117, hereby incorporated by reference herein.

“Spindle extensions” are used to secure automotive chassis components to automotive bodies. Typically there are up to 30 spindle extensions on a “suspension build up pallet.” An operator (or automatic equipment) loads an automotive chassis component, for example a heat shield or even an entire rear suspension module, onto the pallet. The upper ends of the spindle extensions hold the bolts or nuts to secure the chassis component to the body. The lower ends of the spindle extensions have sockets which are engaged by “nut runners,” or nut drivers. The nut runners torque the spindle extensions which in turn torque the bolts into place thus securing the chassis component, carried by the pallet, to the body.

The spindle extensions must be able to be moved in x axis and y axis directions (i.e. in a plane parallel to the plane of the pallet and hence automotive body) and well as radially. The x and y motion (and z axis, or vertical, motion) is handled via the pallet. See the above-referenced patent applications. The radial motion is provided by the spindle extension. More particularly, the spindle extension, while holding the bolt or nut in place, must provide some “positional compliance” or “locational tolerance.” Such positional compliance or locational tolerance is required to compensate for manufacturing tolerances inherent in the various chassis components and in the body itself, and to allow the threads of the bolt to align themselves with the threads of the nut to prevent cross-threading during running of the bolt by the nut runner.

Currently spindle extensions include an expensive spherical bearing which provides movement in the radial direction and thus positional compliance and/or locational tolerance. To prevent excess radial motion, the current spindle extension must be loosely held by some type of device, for example a bracket having a hole which is slightly larger in diameter than the diameter of the spindle extension. Since the spindle extension is located in the hole in the bracket, the hole necessarily limits the radial travel of the spindle extension.

It is desirable to eliminate the expensive spherical bearing and the bracket in the spindle extensions, while still providing for radial movement.

### SUMMARY OF THE INVENTION

The present invention is apparatus for securing an automotive chassis component to an automotive body. The apparatus comprises a vertically movable pallet, and a spindle extension mounted on the pallet generally perpendicularly thereto. The spindle extension includes a shaft, a bolt socket on an upper end of the shaft, and a driver socket on a lower end of the shaft. The spindle extension includes a spring operable between the shaft and the pallet which functions to normally bias the spindle extension to the generally perpendicular orientation relative to the pallet.

The spring can be a compression spring. The apparatus can include a housing mounted to the pallet. The spring can be positioned between the housing and the lower end of the shaft. The apparatus can include a bushing below the housing. The spring can be mounted on the bushing. The bushing can include first and second retainers thereon. The first retainer can be positioned at an upper end of the spring, and the second retainer can be positioned at a lower end of the spring.

The spring can be a tension spring. The spring can be positioned between the housing and the upper end of the shaft. The bushing can be above the housing. The spring can have an upper end secured to the bushing and a lower end secured to the housing.

The apparatus can include a handle mounted to the shaft to enable an operator to lower the spindle extension relative to the pallet from a raised position. A spring can be operable between said shaft and the pallet which functions to return the spindle extension to the raised position. The spring can be a compression spring. The spring can be operable between the shaft and the bushing.

These and other features and advantages of the present invention will become more readily apparent during the following detailed description taken in conjunction with the drawings herein, in which:

### BRIEF DESCRIPTION OF THE DRAWINGS

FIG. 1 is a partial perspective view of a suspension build up pallet with a spindle extension according to the present invention;

FIG. 2 is a perspective view of the spindle extension of FIG. 1;

FIGS. 3A and 3B are side views of the spindle extension of FIGS. 1 and 2 in undeflected and deflected states, respectively;

FIG. 4 is a perspective view of another spindle extension according to the present invention; and

FIGS. 5A and 5B are side views of the spindle extension of FIG. 4 in undeflected and deflected states, respectively.

### DETAILED DESCRIPTION OF THE INVENTION

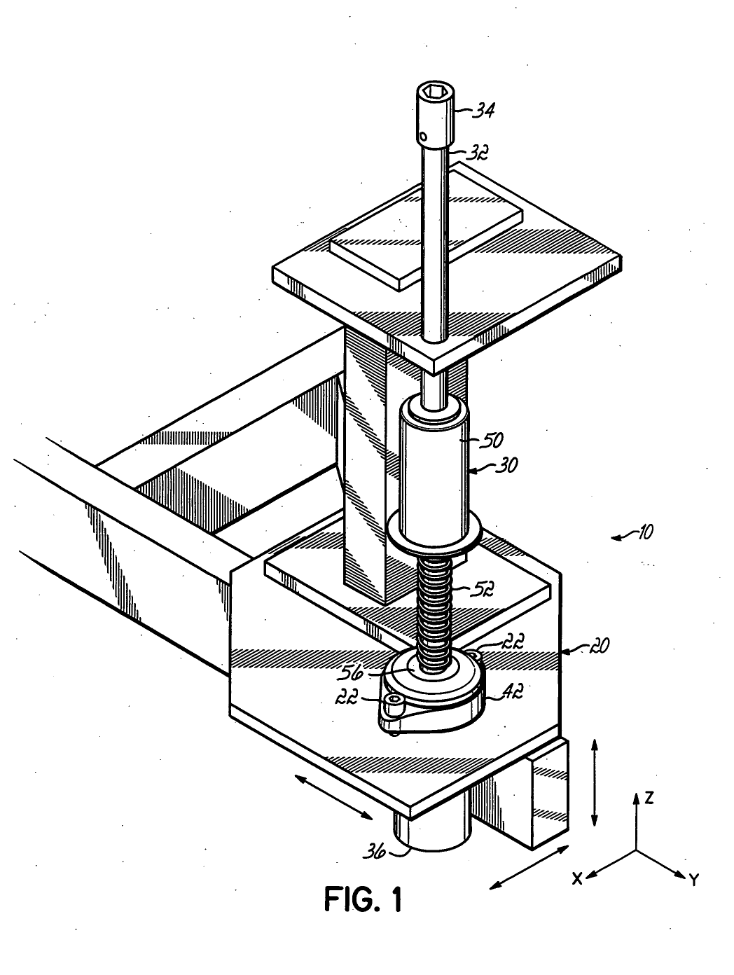

Referring first to FIG. 1, there is illustrated apparatus 10 for securing an automotive chassis component (not shown) to an automotive body (not shown). The apparatus 10 comprises a vertically movable (in the direction of the z axis) pallet 20 and a spindle extension 30 mounted on the pallet 20 generally perpendicularly thereto. Pallet 20 can also be movable in the directions of the x and y axes.

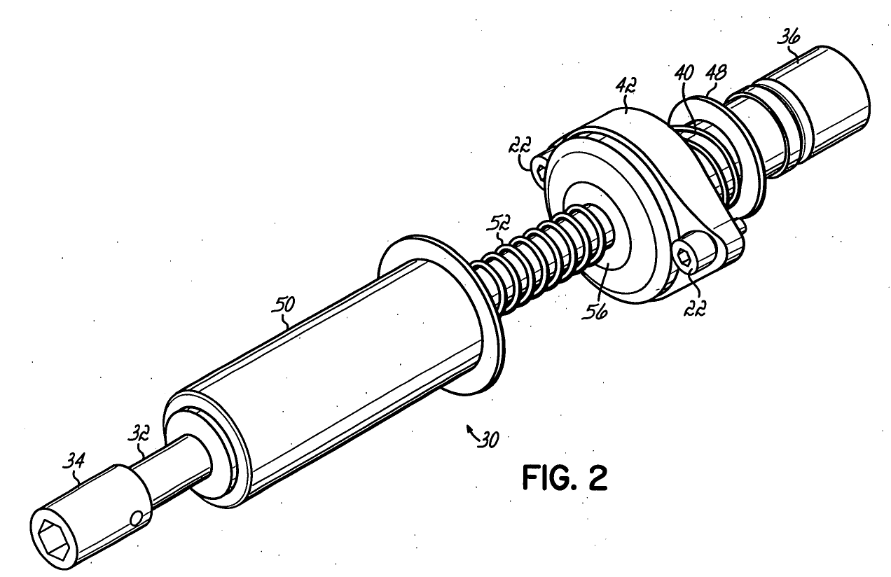

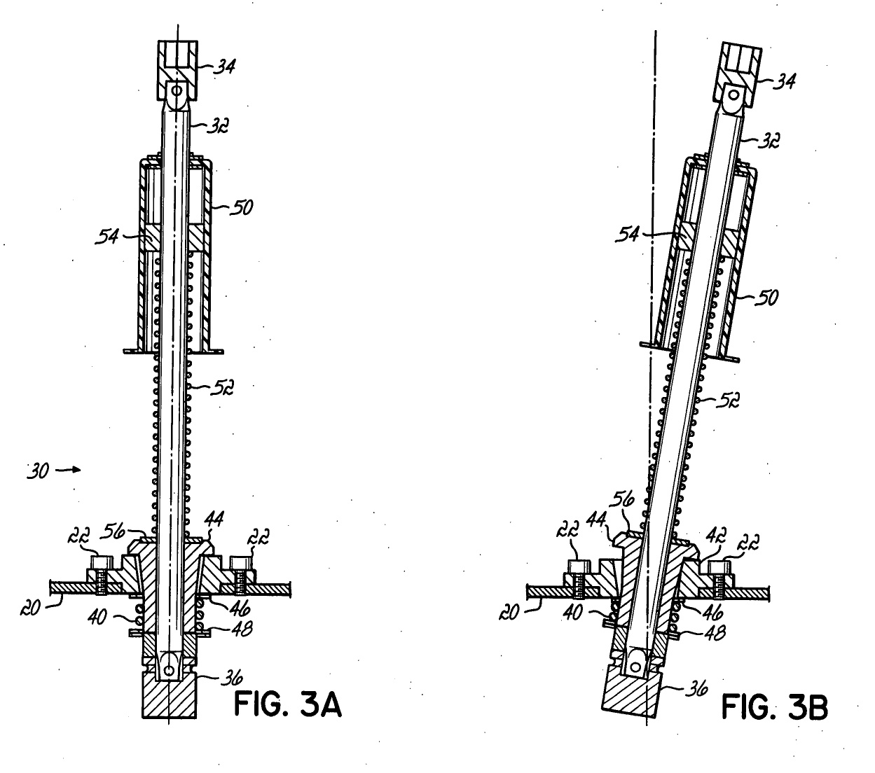

Referring now to FIGS. 2, 3A and 3B, spindle extension 30 includes a shaft 32, a bolt socket 34 on an upper end of the shaft 32, and a driver socket 36 on a lower end of the shaft 32. The spindle extension 30 includes a spring 40 operable between the shaft 32 and the pallet 20 which functions to normally bias the spindle extension 30 to the generally perpendicular orientation relative to the pallet 20.

Spring 40 can be a compression spring. A housing 42 can be mounted to the pallet 20 via screws 22. The spring 40 can be positioned between the housing 42 and the lower end of the shaft 32. A bushing 44 can be positioned to be below the housing 42. The bushing 44 can include first and second retainers 46, 48, respectively. The first retainer 46 can be positioned at an upper end of the spring 40 and the second retainer can be positioned at a lower end of the spring 40. As shown in FIG. 3B, pivoting of the spindle extension 30 relative to the pallet 20 is resisted by the compression spring 40 which is compressed by retainers 46 and 48; once the force applied to spindle extension 30 causing it to pivot is removed, compression spring 40 acting through retainers 46 and 48 causes the spindle extension 30 to return to the generally perpendicular orientation relative to the pallet 20.

The spindle extension 30 can include a handle 50 mounted to the shaft 32. Handle 50 enables an operator to lower the spindle extension 30 relative to the pallet 20 from a raised position to place a bolt in bolt socket 34, and then to raise the spindle extension 30 relative to the pallet 20 so as to pass the bolt through the bolt hole of the chassis component carried by the pallet 20 to be secured to the body. Handle 50, when moved downwardly relative to pallet 20, causes shaft 32 to telescope downwardly through bushing 44. A spring, for example compression spring 52, operable between the shaft 32 and the pallet 20, can be included to return the spindle extension 30 to the raised position when an operator releases handle 50. An upper end of spring 52 can bear against a retainer 54 secured to shaft 32. A lower end of spring 52 can bear against a spacer 56, which itself can bear against bushing 44. Thus, downward movement of shaft 32 via handle 50 compresses spring 54 between retainer 54 and spacer 56; releasing handle 50 permits compression spring 52 to extend moving shaft 32 and bolt socket 34 to the original raised position.

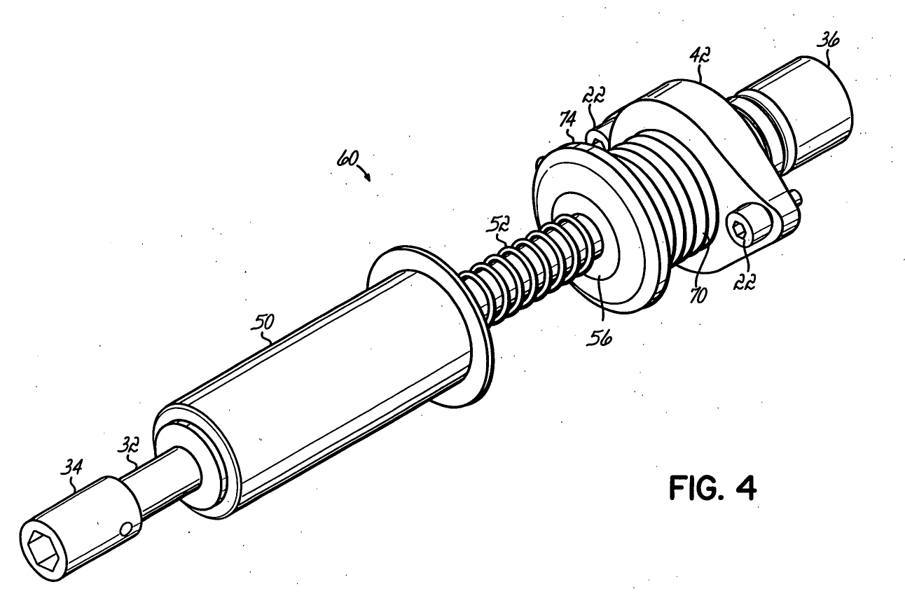

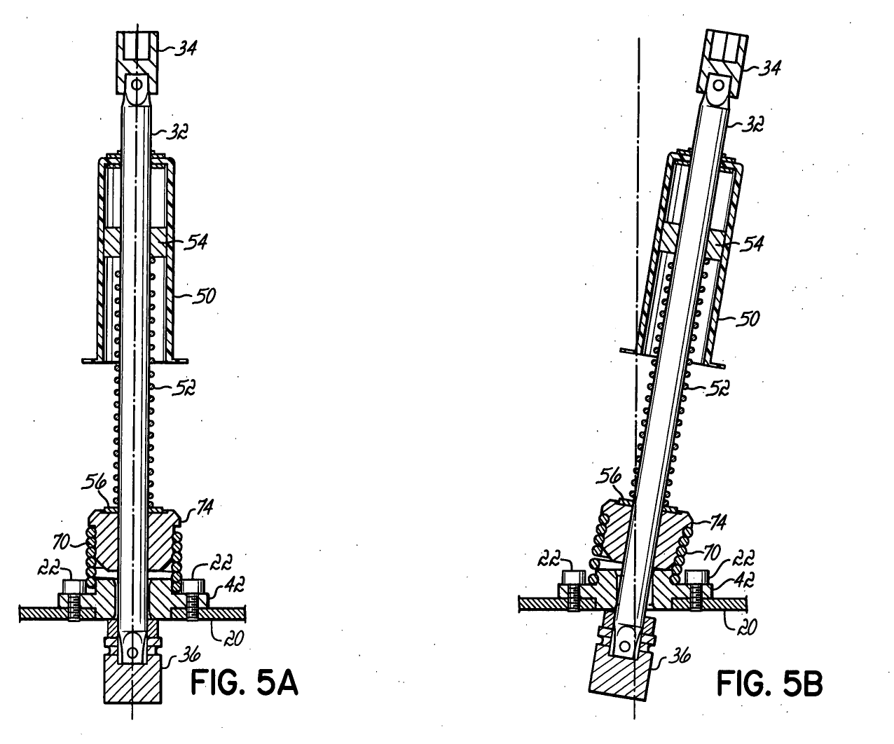

Referring now to FIG. 4, another spindle extension 60 according to the present invention is illustrated. With like numbers representing like elements, spring 70 can be a tension spring. The spring 70 can be positioned between the housing 42 and the upper end of the shaft 32. A bushing 74 can be positioned to be above the housing 42. The bushing 74 can have the upper end of the spring 70 mounted thereto, and the housing 42 can have the lower end of the spring 70 mounted thereto. As shown in FIG. 5B, pivoting of the spindle extension 30 relative to the pallet 20 is resisted by the tension spring 70 which is stretched between bushing 74 and housing 42; once the force applied to spindle extension 60 causing it to pivot is removed, tension spring 70 acting through bushing 74 and housing 42 causes spindle extension 60 to return to the generally perpendicular orientation relative to the pallet 20.

Those skilled in the art will readily recognize numerous adaptations and modifications which can be made to the present invention and which can result in an improved spindle extension for securing automotive chassis components to automotive bodies, yet all of which will fall within the spirit and scope of the present invention as defined in the following claims. Accordingly, the invention is to be limited only by the scope of the following claims and their equivalents.

1. Apparatus for securing an automotive chassis component to an automotive body comprising:
a vertically movable pallet,
a spindle extension mounted on said pallet generally perpendicularly thereto,
said spindle extension including a shaft, a bolt socket on an upper end of said shaft, and a driver socket on a lower end of said shaft,
said spindle extension including a spring operable between said shaft and said pallet which functions to normally bias said spindle extension to the generally perpendicular orientation relative to said pallet.

2. The apparatus of claim 1 wherein said spring is a compression spring.

3. The apparatus of claim 2 including a housing mounted to said pallet, said spring positioned between said housing and said lower end of said shaft.

4. The apparatus of claim 3 including a bushing below said housing, said spring mounted on said bushing, said bushing including first and second retainers thereon, said first retainer positioned at an upper end of said spring, said second retainer positioned at a lower end of said spring.

5. The apparatus of claim 1 wherein said spring is a tension spring.

6. The apparatus of claim 5 including a housing mounted to said pallet, said spring positioned between said housing and said upper end of said shaft.

7. The apparatus of claim 6 including a bushing above said housing, said spring having an upper end secured to said bushing and a lower end secured to said housing.

8. The apparatus of claim 1 including a handle mounted to said shaft to enable an operator to lower said spindle extension relative to said pallet from a raised position, and a spring operable between said shaft and said pallet which functions to return said spindle extension to the raised position.

9. The apparatus of claim 8 wherein said spring is a compression spring.

10. The apparatus of claim 9 including a housing mounted to said pallet and a bushing associated with said housing, said spring operable between said shaft and said bushing.
